(19) United States
(12) Patent Application Publication
(10) Pub. No.: US 2003/0084985 A1
(43) Pub. Date: May 8, 2003

(54) Laminating machine for manufacturing corrugated cardboard and method of use

(76) Inventor: Fahri Iren, Berlin (DE)

Correspondence Address: Nash & Titus, LLC, Suite 1000, 3415 Brookeville Road, Brookeville, MD, 20833, US

(21) Appl. No.: 10/255,035

(22) Filed: Sep. 26, 2002

(30) Foreign Application Priority Data
Sep. 27, 2001 (DE) FRG 101 47 824.0

(51) Int. Cl. B31F 1/20; B32B 31/00

(52) U.S. Cl. 156/210; 156/64; 156/350; 156/352; 156/367; 156/378; 156/379; 156/470

(57) ABSTRACT

The invention is relative to a method of producing corrugated cardboard in which a corrugated [fluting] web [medium] (6b) is laminated onto a covering web (6c), gas is blown onto a longitudinal running side of a corrugated cardboard web and a separating of the corrugated web (6b) from the covering web (6c) in non-adhered areas of the corrugated cardboard web is detected. The invention is also relative to a laminating machine with a roller arrangement (1, 2, 3) with adjacently arranged rollers that can rotate in opposite directions and with a take-in side (10) and with an ejection side (11) for a corrugated cardboard web (6d) and with at least one blowing means (15) for blowing apart non-adhered areas of the corrugated cardboard web, which means are arranged on the ejection side of the roller arrangement (1, 2, 3) and can be directed onto a longitudinal side of a course for a corrugated cardboard web, and with means (16a, 16b) for detecting blown-apart areas of a corrugated cardboard web, which means are arranged adjacent to the at least one blowing means (15).

The invention is relative to a method of manufacturing corrugated cardboard and to a laminating machine for carrying out such a method.

Laminating machines and methods of manufacturing corrugated cardboard are known in the state of the art. DE 43 07 520 describes a method of laminating paper webs on top of one another in order to manufacture corrugated cardboard in which method the moisture content of at least one of the two paper webs is determined and the amount of glue required for the laminating procedure is correspondingly regulated.

DE 31 38 673 is relative to a control for aligning two running paper webs. The relative displacement of the two paper webs relative to one another is determined and compensated via appropriate devices.

The selected initial settings regarding contact pressure, amount of glue applied and so forth must be checked and, if necessary, adapted to changing external conditions. There is, for example, the problem that a selected amount of glue to be applied is no longer sufficient at a later point in time for a firm adhesive connection, e.g., due to a changing moisture content in the ambient air. The non-adhered areas of the corrugated cardboard web can no longer be used.

The present invention has the problem of improving a method of manufacturing corrugated cardboard and of making available an improved laminating machine for carrying out such a method.

The problem is solved by a method of manufacturing corrugated cardboard in which a corrugated [fluting] web [medium] is laminated onto a covering web, gas is blown onto a longitudinal running side of a corrugated cardboard web and a separating of the corrugated web [from] the covering web in non-adhered areas of the corrugated cardboard web is detected. Basically, the method in accordance with the invention can be used not only on a corrugated web and a covering web but also on any paper webs being laminated onto each other. In particular, other covering webs and/or corrugated webs can already have been laminated onto the corrugated web and/or the covering web. Gas is blown onto the corrugated cardboard web produced by the laminating process immediately after the laminating process. It is advantageous to use air to this end that flows out of air jets directed onto longitudinal sides of the course of the corrugated cardboard web. If areas of the corrugated cardboard web should not be firmly adhered to each other the gas jet blows the corrugated web and the covering web apart. The erroneously laminated areas are rapidly discovered so that at worst a few meters of corrugated cardboard web scrap are produced.

It is preferable if the separating of the corrugated web and of the covering web is detected by suitable detection means and the measured values evaluated and a supply of adhesive increased and/or the advance of the corrugated web or covering web reduced. The detected values are automatically evaluated and supplied, e.g., to a control circuit. The control circuit automatically controls appropriate means for increasing the supply of adhesive or for reducing the advance or for emitting an acoustic or optical signal. It is also possible for a stop to be made after the evaluation of the measured values of the laminating process.

It is preferable if the width of the corrugated cardboard web is determined at first and the air jets subsequently guided into a position adjacent to the longitudinal side of the corrugated cardboard web. Paper webs of different widths are used as needed to manufacture an appropriate corrugated cardboard web. Since the jets or the like have an effective range extending only a few centimeters, the air jets should be positioned in the immediate vicinity of the longitudinal side of the corrugated cardboard web. Thus, the selecting of different widths of the paper rolls creates the need to subsequently guide the jets or the like along the width of the corrugated cardboard web to the longitudinal side of the corrugated cardboard web.

The problem is also solved by a laminating machine with a roller arrangement with adjacently arranged, counter-rotatable rollers with a draw-in side and an ejection side for a corrugated cardboard web and with at least one blowing means arranged on the ejection side of the roller arrangement that can be directed onto a longitudinal side of the course of a corrugated cardboard web for blowing apart non-adhered areas of the corrugated cardboard web and with means for detecting the blown-apart areas of the corrugated cardboard web, which means are arranged adjacent to the at least one air jet.

At least one blowing means and means cooperating with it for detecting the blown-apart, non-adhered corrugated cardboard areas are arranged in a favorable instance at a slight distance from the roller arrangement. The blowing means preferably comprises an air jet. The air jet is directed in such a manner that its air stream is aimed toward a longitudinal side of the course of the corrugated cardboard web. The course of the corrugated cardboard web is that area between the rollers through which the inserted paper webs or the laminated corrugated cardboard web run. In order to achieve a high reliability and precision in the determination of non-adhered areas of the corrugated cardboard web, the air stream of the air jet is directed as precisely and continuously as possible onto a longitudinal side of the corrugated cardboard web running though. On account of the vigorous movement of the corrugated cardboard web during the laminating process the course of the corrugated cardboard web is basically thicker than the corrugated cardboard. Therefore, a deflection roller is preferably arranged along the course of the corrugated cardboard web between the ejection side and the at least one air jet along the width of the course of the corrugated cardboard web. The deflection roller fixes the corrugated cardboard web [so that?] the at least one air jet can be directed more precisely onto the one longitudinal side of the corrugated cardboard web.

The detection means preferably comprises a photocell and a laser directed onto the photocell. The position of the at least one air jet and/or of the detection means can preferably be adjusted along the running side of the corrugated cardboard web by a holding device. The laser beam is guided in such a manner adjacent to the corrugated cardboard web that the blown-apart corrugated cardboard interrupts the light barrier. The holding device comprises, e.g., two parts arranged with substantially mirror symmetry on opposite walls of a frame of a laminating machine. One air jet can be fastened with the laser in an adjustable manner by one part of the holding device in the area of a longitudinal side of the corrugated cardboard web and another air jet with the photocell can be fastened in an adjustable manner by another part of the holding device in the area of the other side of the corrugated cardboard web. Both parts of the holding device can be manually adjusted. It is also possible that the detection means comprises two photocells, in which instance the blowing apart of the corrugated cardboard web on the longitudinal sides alters the incidence of light onto the photocells in a detectable manner.

However, it is also conceivable that the holding device comprises a track arranged along the running width of the corrugated cardboard web on which track the at least one blowing means and/or detection means is/are adjustably arranged. In this instance both ends of the track are permanently connected by a part of a holding device to a frame of a laminating machine. E.g., two carriages are movably arranged on the track, one of which comprises an air jet and a laser and another carriage comprises an air jet and a photocell. Even in this instance air jets are only exemplary embodiments of the blowing means.

It is also conceivable to arrange two lasers and two photocells in an interchanged [transposed] manner on the two longitudinal sides of the corrugated cardboard web.

In a preferred embodiment of the invention the laminating machine comprises a drive for adjusting the position of the blowing means and/or of the detection means. This drive can be provided, e.g., on the carriages.

The roller arrangement can comprise a pressure roller, an upper, corrugated [grooved] roller and a lower, corrugated roller, arranged vertically from above downward, and the deflection roller is arranged horizontally adjacent to the pressure roller. It is also conceivable that the rollers are in an inverted sequence. The upper and the lower corrugated roller can form a first roller slit [nip, gap] and the pressure roller and the upper corrugated roller can form a second roller slit. The actual laminating process can be carried out in the second roller slit.

The at least one blowing means and the detection means should be adjustable, as a function of the width of the paper rolls used, to a corresponding, appropriate width of the corrugated cardboard web. To this end other detection means that detect the width of the corrugated cardboard web on the course of the corrugated cardboard web are preferably connected to the at least one air jet and/or detection means. The other detection means preferably comprise photocells. During the subsequent guiding [into position] of the other detection means they are exposed to a sudden change of the incident light in the area of the longitudinal sides of the corrugated cardboard web The other detection means are preferably connected via a first control circuit to the drive. The changing of the position of the at least one blowing means and/or of the detection means can thus be carried out automatically.

In a preferred embodiment the detection means are connected to a second control circuit for the advance of the corrugated cardboard web and of the covering web or for the glue supply.

The invention is explained in an exemplary manner using two exemplary embodiments and with reference made to three figures.

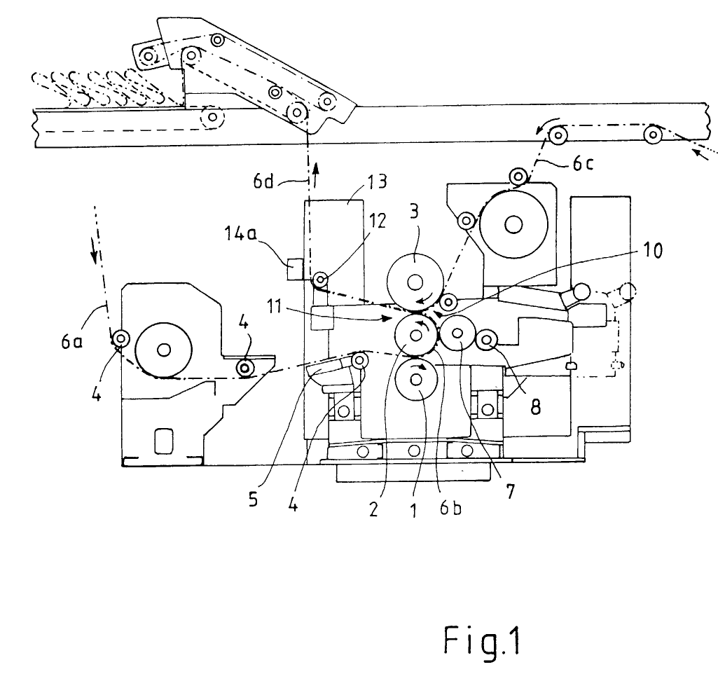

FIG. 1 shows a cross section of a one-sided corrugating [corrugated cardboard] unit in accordance with the invention.

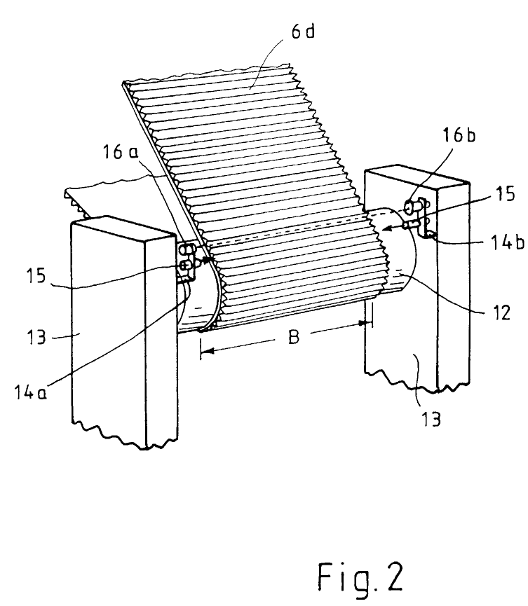

FIG. 2 shows a perspective view of a first arrangement, in accordance with the invention, of air jets and detection means.

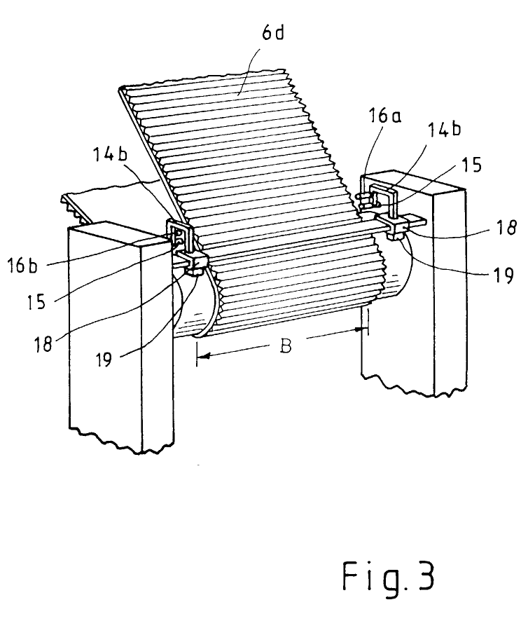

FIG. 3 shows a perspective view of a second arrangement, in accordance with the invention, of air jets and detection means.

A central area of the one-sided corrugating unit in accordance with the invention comprises three rollers 1, 2, 3 arranged vertically over each other. The two lower rollers have the same diameter. The lowest roller is a lower corrugated roller 1 and the middle roller an upper corrugated roller 2. The uppermost of the three rollers is a pressure roller 3. A paper web can be roller off from a paper roll and guided, after alignment by first deflection rollers 4, over moistener 5. Paper web course 6a is represented by a dotted line. The paper web inserted into the one-sided corrugating unit runs in the associated paper web course. Evaporator 5 moistens the one paper web. The one moistened paper web can be more readily deformed than a dry paper web. A good adhesive connection between two paper webs is achieved with less glue in the case in which one paper web is moistened than it is between two dry paper webs.

The one moistened paper web is fed to a first roller slit between upper corrugated roller 2 and lower corrugated roller 1. The upper and the lower corrugated rollers have raised areas and lowered areas along the longitudinal direction of the roller. The raised areas and lowered areas of upper corrugated roller 2 and lower corrugated roller 1 intermesh. After the passage of the one paper web through the first roller slit the one paper web is formed to corrugated cardboard web 6b. Corrugated cardboard web 6b has a corrugated pattern in its longitudinal cross section. The corrugated cardboard web lying on upper corrugated roller 2 is fed approximately halfway around it to a second roller slit. The second roller slit is created by the spaced, parallel arrangement of upper corrugated roller 2 and pressure roller 3.

Glue application roller 7 is provided on the corrugated cardboard web side horizontally adjacent to upper corrugated roller 2. Upper corrugated roller 2 and glue application roller 7 rotate in opposite directions. Glue application roller 7 cooperates with glue squeeze [squeeze-off] roller 8 for regulating the thickness of the coat of glue on glue application roller 7 and therewith the amount of glue applied onto the ridges of corrugated cardboard web 6a.

The actual laminating process takes place in the second roller slit. Here, corrugated cardboard web 6b is adhered under pressure onto covering web 6c. Covering web 6c can be rolled off as another paper web from another paper roll and fed via two deflection rollers 7 [sic-4?] to the second roller slit. A covering web course is also represented as a dotted line. Upper corrugated roller 2 and pressure roller 3 rotate in opposite directions and comprise a take-in side 10 for corrugated cardboard web 6b and covering web 6c. The two webs, that are laminated onto one another after passage through the second roller slit, are ejected at ejection side 11 of roller arrangement 2, 3 in the form of a one-sided corrugated cardboard web 6d. A corrugated cardboard web course is also represented as a dotted line. Deflection roller 12 is rotatably mounted parallel to the second roller slit on the ejection side on laminating machine frame 13. The one-sided corrugated cardboard web is guided around the deflection roller in such a manner that the covering web is in contact with a roller surface of deflection roller 12. In FIG. 1 one-sided corrugated cardboard web 6d runs substantially vertically upward from deflection roller 12.

In FIG. 1 a holding device 14a, 14b for air jets 15 respectively is arranged above the deflection roller on the one-sided corrugating unit frame in the areas of the two ends of the deflection roller. Air jets 15 are designed so that a vigorous stream of air is directed onto each of the longitudinal sides of one-sided corrugated cardboard web 6d. If no satisfactory adhesive connection is achieved during the laminating process, e.g., on account of too little glue applied or insufficient contact pressure, non-adhered areas of the corrugated cardboard web are created in particular in the area of the longitudinal sides of the corrugated cardboard web. The strong stream of air exiting from the two air jets 15 blows the corrugated cardboard web and the covering web apart in the non-adhered areas of the corrugated cardboard web of the longitudinal sides of the corrugated cardboard web. Parts of a light barrier 16a, 16b are provided adjacent to the two air jets on the associated holding devices 14a, 14b along the further course of the corrugated cardboard web. Laser 16a of the light barrier is held by the one holding device 14a. Laser 16a is directed onto photocell 16b held by the other holding device 14b. The parts of light barrier 16a, 16b and the two air jets 15 are arranged so closely to each other that the blown-apart, non-adhered corrugated cardboard web areas initiate [release, start] light barrier 16a, 16b. The initiation of light barrier 61a, 16b transmits a signal to a first control circuit that controls a drive of the laminating machine for stopping the laminating machine or a servomotor for changing the interval of the glue application roller to the glue squeeze roller for dosing glue.

FIG. 2 shows deflection roller 12 for one-sided corrugated cardboard web 6d with two holders 14a, 14b and air jets 15 mounted on each holder 14a, 14b and with photocell 16b arranged along the course of the corrugated cardboard web behind the two air jets 15 and with laser 16a. Deflection roller 12 is rotatably supported in two bearings of one-sided corrugating unit frame 13. The two bearings are let into walls of corrugating unit frame 13. One of holders 14a is provided in each wall of corrugating unit frame 13. Holders 14a, 14b can be adjusted along width 13 of the corrugated cardboard web. Holders 14a, 14b can be adjusted in such a manner that air jets 15 of each longitudinal side of the corrugated cardboard web can be fixed at a distance of approximately 5 cm. The position of air jets 15 along width 13 of the corrugated cardboard web can be adapted to the paper web width being used. Laser 16a and photocell 16b are permanently connected to associated air jet 15 and held by holders 14a, 14b.

FIG. 3 shows another embodiment of the one-sided corrugating unit of the invention. In this embodiment a track 17 is mounted between the two walls of corrugating unit frame 13. The two ends of track 17 are held by the two holders 14a, 14b. Two carriages 18 driven by an electromotor are placed on track 17. Air jet 14 and photocell 16b are fastened on the one carriage 18 and the other air jet 15 and laser 16a are fastened on the other carriage. The two carriages 18 can move and be driven in the longitudinal direction of track 17. Each carriage 18 comprises another photocell 19 directed onto corrugated cardboard web 6d. Width B of corrugated cardboard web 6d can be determined by the two other photocells 19. If the two carriages run toward one another from the walls, the incidence of light onto the two other photocells 19 changes abruptly in the area of the longitudinal sides of corrugated cardboard web 6d. The two other photocells 19 are electrically connected via the second control circuit to the associated drives of the carriages on the track.

1. A method of producing corrugated cardboard in which a corrugated [fluting] web [medium] (6b) is laminated onto a covering web (6c), gas is blown onto a longitudinal running side of a corrugated cardboard web and a separating of the corrugated web (6b) from the covering web (6c) in non-adhered areas of the corrugated cardboard web is detected.

2. The method of producing corrugated cardboard according to claim 1, characterized in that measured values are evaluated and a supply of adhesive increased and/or the advance of the corrugated web (6b) and the covering web (6c) reduced and/or an acoustic and/or an optical signal is/are emitted.

3. The method of producing corrugated cardboard according to claim 1, characterized in that measured values are evaluated and the laminating process stopped.

4. The method of producing corrugated cardboard according to the preceding claims, characterized in that a width (B) of the corrugated cardboard web is determined and the blowing means (15) subsequently guided into a position adjacent to the longitudinal side of the corrugated cardboard web.

5. A laminating machine for carrying out the methods according to claims 1 to 4 with
A roller arrangement (1, 2, 3) with adjacently arranged rollers that can rotate in opposite directions and with a take-in side (10) and with an ejection side (11) for a corrugated cardboard web (6d) and
At least one blowing means (15) for blowing apart non-adhered areas of the corrugated cardboard web, which means are arranged on the ejection side of the roller arrangement (1, 2, 3) and can be directed onto a longitudinal side of a course for a corrugated cardboard web, and
Means (16a, 16b) for detecting blown-apart areas of a corrugated cardboard web, which means are arranged adjacent to the at least one blowing means (15).

6. The laminating machine according to claim 5, characterized in that as concerns the corrugated cardboard web course (6d) between the ejection side (11) and the at least one blowing means (15) a deflection roller (12) is arranged along one width of the corrugated cardboard web.

7. The laminating machine according to claim 5 or 6, characterized in that the at least one blowing means (15) is arranged as concerns the corrugated cardboard web course (6d) between the detection means (16a, 16b) and the ejection side (11).

8. The laminating machine according to claims 5 to 7, characterized in that the position of the at least one blowing means (15) and/or of the detection means (16a, 16b) can be adjusted with a holding device (14a, 14b) along one width of the corrugated cardboard web course.

9. The laminating machine according to claim 8, characterized in that the holding device (14a, 14b) comprises a track (17) arranged along the width of the corrugated cardboard web course on which track the at least one blowing means (15) and/or detection means (16a, 16b) are movably arranged.

10. The laminating machine according to claims 5 to 9, characterized by a drive for adjusting the position of the at least one blowing means (15) and/or detection means (16a, 16b).

11. The laminating machine according to claims 5 to 10, characterized in that other detection means (19) are connected to the at least one blowing means (15) and/or detection means (16a, 16b) and are directed onto the corrugated cardboard web course in order to determine a width (B) of the corrugated cardboard web.

12. The laminating machine according to claims 10 and 11, characterized in that the other detection means (19) are connected via a first control circuit to the drive.

13. The laminating machine according to the preceding claims, characterized in that the detection means comprise a photocell (16b) and a laser (16a) directed onto the photocell (16b) that are arranged on a longitudinal side of the course of the corrugated cardboard web.

14. The laminating machine according to the preceding claims, characterized in that the roller arrangement (1, 2, 3) comprises a pressure roller (3), an upper, corrugated [grooved] (2) roller and a lower, corrugated roller (1), arranged vertically from above downward, and that the deflection roller (12) is arranged horizontally adjacent to the pressure roller (3).

15. The laminating machine according to the preceding claims, characterized in that the detection means (15) are connected to a second control circuit for the advance of the corrugated cardboard web (6a) and of the covering web (6c) and/or for the glue supply.
